(19) United States
(12) Patent Application Publication
(10) Pub. No.: US 2003/0180453 A1
(43) Pub. Date: Sep. 25, 2003

(54) EPOXY APPLICATION SYSTEM AND METHOD

(76) Inventors: Patrick J. Burke, Corning, NY (US); William J. Miller, Horseheads, NY (US); Mark L. Morrell, Horseheads, NY (US)

Correspondence Address: CORNING INCORPORATED, SP-TI-3-1, CORNING, NY, 14831

(21) Appl. No.: 09/974,518

(22) Filed: Oct. 9, 2001

(51) Int. Cl. B05C 5/00

(52) U.S. Cl. 427/162; 427/385.5; 118/300; 239/104

(57) ABSTRACT

An epoxy application system and method for applying an epoxy having particulate constituents to an optical component including an epoxy reservoir, an applicator, and an actuator mechanically connected to the epoxy reservoir, the actuator operable to periodically invert the epoxy reservoir. A timing circuit is provided in one embodiment to periodically invert the epoxy reservoir. A vacuum device of one embodiment vacuums excess epoxy. Another embodiment of the epoxy application system includes an energy source for providing UV energy through a light guide. One embodiment further includes a UV light energy detector to measure UV light energy emitted through the light guide and a controller to determine a cure time based on the measured UV light energy. In another embodiment, a monitoring system such as a camera is provided to ensure provision of the UV light energy for the determined cure time.

### BACKGROUND OF THE INVENTION

1. Field of the Invention

The present invention is directed to automated manufacturing of fiber optic components. More specifically, the present invention is directed to epoxy application systems and methods for applying epoxy to fiber optic components.

2. Description of Related Art

Overclad fiber optic couplers are a type of fused fiber coupler wherein the coupling region is enclosed within a layer of matrix glass. An overclad fiber optical coupler, is formed by inserting a plurality of optical waveguide fibers, from which the polymer coating has been removed, into the bore of a glass capillary tube to form a coupler preform. The tube bore typically has enlarged funnel-shaped end portions to facilitate the insertion of optical fibers. The midregion of the coupler preform is heated to collapse the glass tube onto the fibers and then, the coupler preform is stretched until the desired coupling characteristics are obtained. Various types of overclad fiber optic couplers and methods of making such couplers are disclosed in U.S. Pat. No. Re. 35,138, U.S. Pat. No. 4,902,324, U.S. Pat. No. 4,979,972, U.S. Pat. No. 5,011,251, U.S. Pat. No. 5,251,276 and U.S. Pat. No. 5,268,014.

The methods disclosed in these patents include many manual operations. For instance, the optical fibers used to manufacture such optical couplers have to be stripped, inserted into the tube, heated and the glass tube is drawn together with the optical fibers. If the stripped portion of the optical fiber is at the end of the fiber, it can be provided with a low reflectance termination. After the optical coupler has been formed by stretching the overclad tube and fibers, a glue such as an ultraviolet (UV) curable epoxy is inserted into the uncollapsed ends of the glass tube bore to provide the fibers with pull strength. Manual processing of these fiber preparation steps however, is time consuming and is subject to the particular manipulations of the operator which negatively impacts the process reproducibility and detriment the optical characteristics of the manufactured optical couplers.

To eliminate such manual steps, an improved apparatus and manufacturing method has been disclosed in U.S. Pat. No. 6,092,394 to Backer et al. which automates substantially all of the above noted process steps to allow automated manufacture of fiber optic couplers. It has been found that better quality couplers can be made at a greater rate and with more consistency using the invention of Backer et al., than can be made by the aforementioned manual process.

In this regard, the apparatus disclosed in Backer et al. includes a dispensing device for automatically dispensing glue into the bore of the glass tube after the coupler has been formed. In addition, the apparatus of Backer et al. also includes a device for curing the glue after the glue has been dispensed into the bore. The device for curing the glue includes a UV light source sequentially positioned at each of the ends of the glass tube. Thus, it is known to dispense glue into the uncollapsed ends of the bore of the glass tube after the tapered coupling region has been formed, and to cure the glue by directing UV light beams at each of the end regions of the glass tube.

However, as described in further detail herein below, several limitations have been found by the present inventors in the apparatus and method disclosed in Backer et al. which, under some circumstances, can cause small but significant product variations. Theses variations may reduce product reliability. In particular, variations can occur during the step of applying the glue such as an ultraviolet (UV) curable epoxy into the uncollapsed ends of the tube bore and also during the step of curing the glue. In addition, the apparatus and method disclosed in Backer et al. has been found to require significant maintenance in order to minimize such variations and to ensure proper operation of the apparatus. Therefore, there exists an unfulfilled need for a further improved apparatus and method that will minimize these variations and maintenance issues.

### SUMMARY OF THE INVENTION

In using the apparatus and method disclosed in Backer et al., the present inventors have found that the epoxy contains various particulate constituents that settle due to gravity. When such settling of particulate constituents occurrs, the epoxy is no longer homogeneous. This causes variation in the expansion characteristics of the epoxy. For instance, the epoxy constituents may distribute unevenly, causing uneven and possibly incresed residual stresses in the multiclad device, thereby reducing the reliability of the device. This problem of settling particulate constituents and the variation in the manufactured optical multiclad devices caused by the settling problem is exacerbated when the manufacturing process is interrupted for a duration of time such as during a production shutdown or during maintenance or repair of other stations or machines used in manufacturing the optical multiclad device.

In addition, due to the space constraints, even properly applying the epoxy to the uncollapsed ends of the tube bore has been found to be difficult. The angled orientation of the epoxy applicator in relation to a substantially vertical glass tube bore makes accurate application of the epoxy relatively difficult. Furthermore, the residual epoxy tends to become build up around the applicator tip thereby clogging the opening, necessitating frequent maintenance cleaning. Such frequent cleaning further exacerbated the above noted settling problems.

Moreover, also due to the space constraints, the curing energy such as UV light energy can be more easily provided to the epoxy in the glass tube of the multiclad device using a light guide such as a liquid filled light guide. The liquid filled light guide movably positioned on a stage allows the UV light source to be located away from the tube bore. The liquid filled light guide conveying the UV light energy from the UV light source to the epoxy. However, the present inventors have found that over time and use, the liquid in the light guides degrades, which negatively impacts the amount of UV light energy conveyed by the light guide, correspondingly reducing the UV light energy provided to cure the applied epoxy. Consequently, the degradation of the liquid filled light guide also causes variation in the manufactured multiclad device. In this regard, the apparatus and method disclosed in Backer et al. can not ensure that a required amount of UV light energy is in fact, provided to the epoxy to ensure desired curing.

In view of the foregoing, the epoxy application system in accordance with one embodiment of the present invention has the advantage of providing an effective apparatus and method for applying a curable epoxy that maintains homogeneity of the particulate constituents in the epoxy.

Another embodiment has the advantage of allowing proper application of the epoxy to the uncollapsed ends of the tube bore while minimizing clogging and the corresponding cleaning maintenance requirements.

Yet embodiment of the present invention has the advantage of providing an effective apparatus and method for ensuring provision of proper level of energy to cure the epoxy despite the degradation of the liquid filled light guide.

The above noted advantages and others are obtained by an epoxy application system for applying a liquid epoxy having particulate constituents to an optical component in accordance with one embodiment of the present invention, the epoxy application system including an epoxy reservoir having an axis and being movable to a park position in which the epoxy reservoir is positioned horizontally in a manner that gravity acts substantially perpendicular to the axis, an applicator connected to the epoxy reservoir, the applicator including an applicator tip with an opening for dispensing the epoxy from the epoxy reservoir to the optical component, and an actuator mechanically connected to the epoxy reservoir, the actuator being operable to periodically invert the epoxy reservoir when the epoxy reservoir is in the park position to substantially maintain homogeneity of the particulate constituents in the epoxy. In one embodiment of the present invention, the actuator is a pneumatic actuator, a hydraulic actuator, or an electric motor. Preferably, the applicator is fixedly mounted to the epoxy reservoir and is rotated with the epoxy reservoir, the epoxy reservoir, the applicator, and the actuator being mounted on a movable stage. The applicator also preferably includes a bent portion to facilitate application of the epoxy.

In accordance with another embodiment, the epoxy application system further includes a timing circuit adapted to periodically actuate the actuator based on settling characteristics of the epoxy. In this regard, the actuator is adapted to invert the epoxy reservoir 180 degrees about the axis upon actuation, preferably alternating the rotation between a clockwise direction rotation and a counter-clockwise direction rotation. In accordance with another embodiment of the present invention, the epoxy application system includes a vacuum device proximate to the opening of the applicator tip when the epoxy reservoir is in the park position, the vacuum device being adapted to vacuum excess epoxy dripping from the opening of the applicator tip.

Furthermore, in yet another embodiment, the epoxy application system further includes an energy source for providing curing energy to cure the epoxy applied to the optical component. In one embodiment, the energy source is a ultraviolet (UV) light source for providing UV light energy and includes a liquid filled light guide for conveying the UV light energy from the UV light source to the epoxy applied to the optical component, the light guide including one end optically connected to the UV light source and a second end adapted to emit the UV light energy from the UV light source. In this regard, in one preferred embodiment, the epoxy application system further includes at least one UV light energy detector adapted to measure UV light energy emitted at the second end of the light guide. A controller is also provided to determine a cure time required to cure the epoxy applied to the optical component based on the UV light energy emitted by the light guide as measured by the UV light energy detector. A monitoring system is provided in the epoxy application system to ensure provision of the UV light energy for at least the determined cure time, the monitoring system being a camera vision system in one embodiment.

In accordance with another aspect of the present invention, the above noted advantages are attained by a method for applying an epoxy having plurality of constituents to an optical component comprising the steps of providing an epoxy reservoir having an axis, providing an applicator connected to the epoxy reservoir for dispensing the epoxy from the epoxy reservoir, positioning the epoxy reservoir horizontally such that gravity acts substantially perpendicular to the axis, and periodically inverting the epoxy reservoir to substantially maintain homogeneity of the plurality of constituents in the epoxy.

In accordance with one embodiment of the present method, the epoxy reservoir and the applicator are mounted on a movable stage and further includes the step of moving the stage to position the applicator proximate to the optical component to allow application of the epoxy thereto. Another embodiment of the present method further includes the step of inverting the epoxy reservoir periodically based on settling characteristics of the epoxy. In this regard, the step of inverting the epoxy reservoir includes the step of rotating the epoxy reservoir 180 degrees along the axis alternating between a clockwise direction rotation and a counter-clockwise direction rotation. In accordance with another embodiment, the applicator includes an applicator tip with an opening an opening and the present method further includes the step of vacuuming the opening of the applicator tip to remove excess epoxy dripping from the opening.

In accordance with another embodiment, the present method also includes the step of curing the epoxy applied to the optical component. In this regard, the step of curing includes irradiating the epoxy with curing energy. In one preferred embodiment, UV light energy is provided to cure the epoxy and is conveyed from a UV light source to the epoxy applied to the optical component through a liquid filled light guide. In one preferred embodiment, the present method also further includes the step of measuring UV light energy emitted by the light guide and in another embodiment, also includes the step of determining a cure time required to cure the epoxy applied to the optical component based on the measured UV light energy emitted by the light guide. In this regard, the present embodiment also preferably include the step of monitoring time duration of providing the UV light energy to ensure UV light energy is provided to the epoxy applied to the optical component for at least the determined cure time.

These and other features and advantages of the present invention will become more apparent from the following detailed description of the preferred embodiments of the present invention when viewed in conjunction with the accompanying drawings.

### BRIEF DESCRIPTION OF THE DRAWINGS

FIG. 1 is a frontal view of an epoxy application station that incorporates two epoxy application systems in accordance with one embodiment of the present invention.

FIG. 2 is a right side view of the epoxy application station of FIG. 11 more clearly showing the epoxy application systems.

FIG. 3 is an enlarged perspective view of the upper epoxy application system of FIG. 1.

FIG. 4 is a schematic illustration of various components of an epoxy application system in accordance with the present embodiment.

FIG. 5 is a schematic illustration of an optional monitoring system in accordance the present embodiment.

FIG. 6 is a flow chart illustrating the method for applying an epoxy having plurality of constituents to an optical component in accordance with the present embodiment.

### DETAILED DESCRIPTION OF THE PREFERRED EMBODIMENT

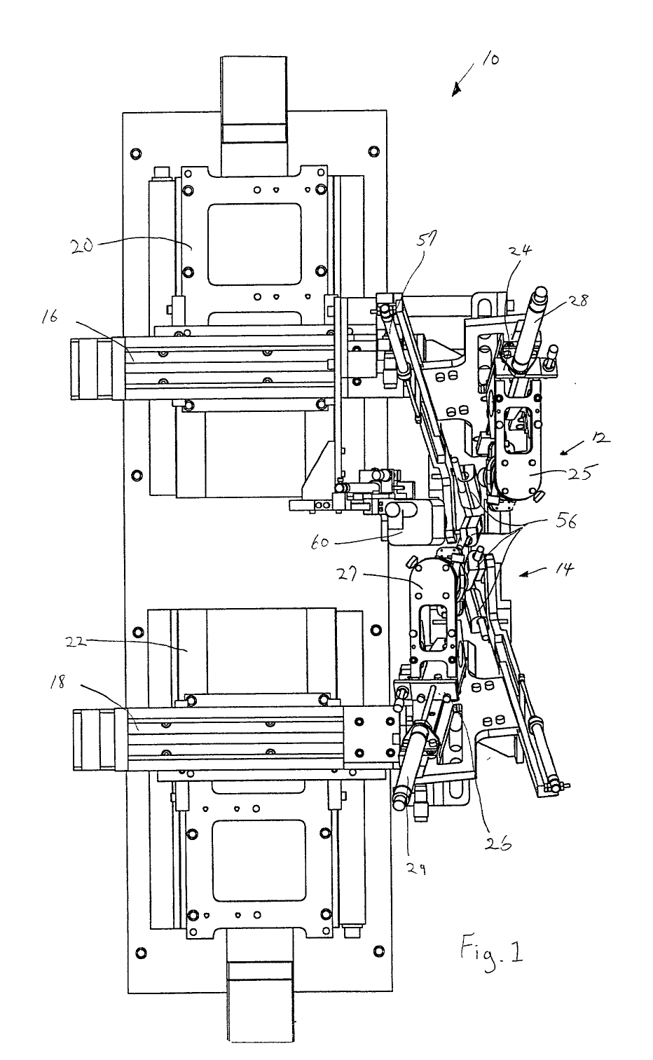

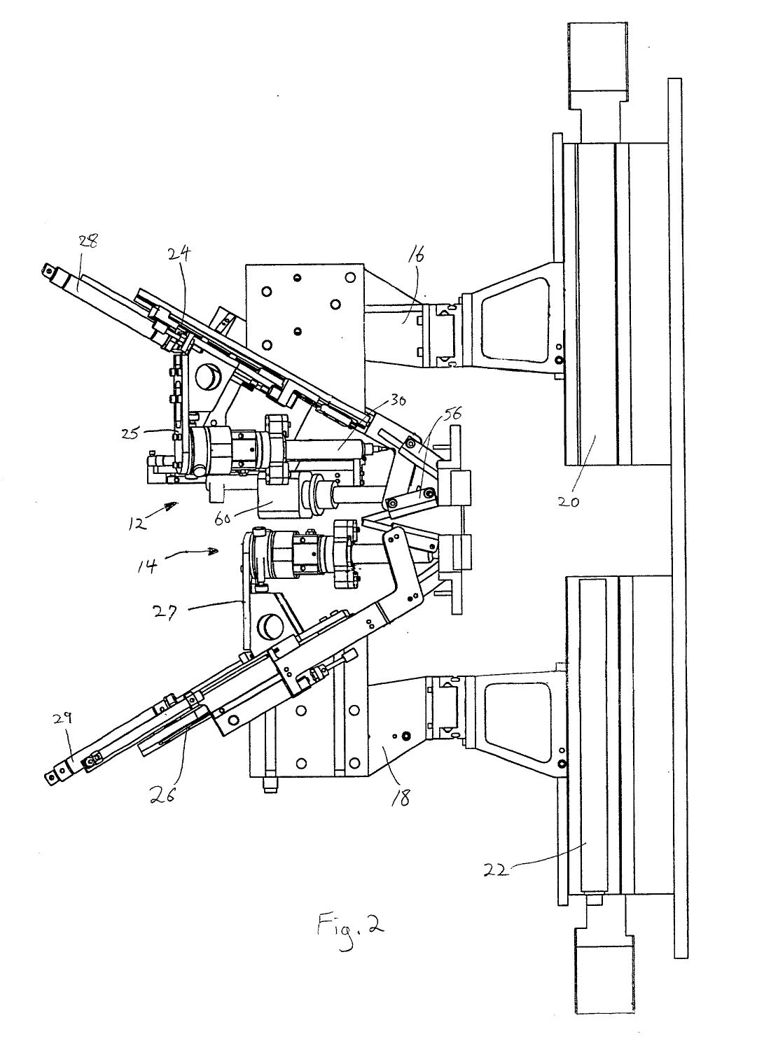

FIGS. 1 and 2 show an epoxy application station 10 that incorporates two epoxy application systems 12 and 14 in accordance with one embodiment of the present invention as described more fully below. FIG. 1 shows a frontal view of the epoxy application station while FIG. 2 shows a right side view. The epoxy application station 10 shown is used in the manufacture of optical components such as multiclad devices, fused fiber couplers, or other optical devices. As will be evident by the discussion herein below, the epoxy application systems 12 and 14 provides an effective apparatus for applying a curable epoxy that maintains homogeneity of the particulate constituents in the epoxy while facilitating proper epoxy application and minimizing clogging and maintenance requirements. Moreover, as will be explained in detail below, the epoxy application systems 12 and 14 also ensures provision of proper level of energy to cure the epoxy despite the degradation of the light guide.

It should initially be noted that whereas in the illustrated embodiment of the epoxy application station 10 is provided with two epoxy application systems 12 and 14, in other embodiments, the epoxy application station 10 may be provided with any number of such systems including one, three, or even more such systems depending on the specific application and design of the epoxy application station. Thus, the present invention is directed to the aspects of the epoxy application system itself regardless of how many of such systems are used in an epoxy application station.

As can be seen in both FIGS. 1 and 2, the epoxy application systems 12 and 14 are mounted on lateral stages 16 and 18 respectively to allow the epoxy application systems 12 and 14 to be displaced laterally. In addition, the lateral stages 16 and 18 are correspondingly mounted to vertical stages 20 and 22 respectively to allow vertical displacement of the epoxy application systems 12 and 14. Moreover, as can be more clearly seen in FIG. 2, each of the epoxy application systems 12 and 14 in accordance with the illustrated embodiment are mounted on diagonal stages 24 and 26 via mounts 25 and 27 respectively. The epoxy application systems 12 and 14 are diagonally displaceable into proper position for application of the epoxy by actuating cylinders 28 and 29 respectively, these cylinders being shown in a retracted position in FIG. 2 so that the epoxy application systems 12 and 14 are in their respective park positions. The stages described above can include various motors or actuators that operate electrically, pneumatically, or hydraulically and any other appropriate devices for allowing movement of the epoxy application systems 12 and 14 such as gears, racks, shafts, etc.

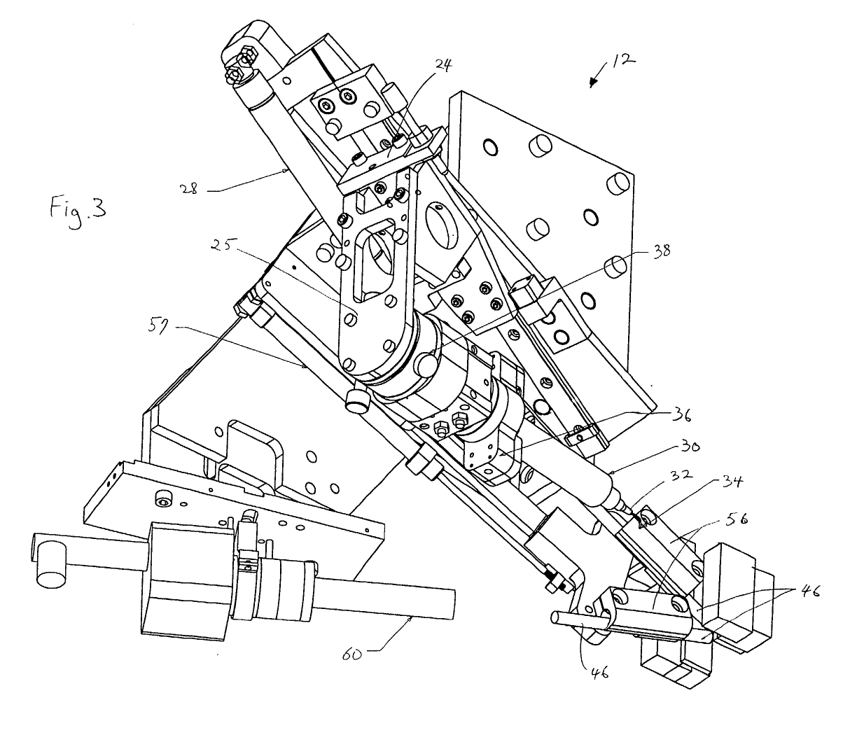

An enlarged perspective view of the epoxy application system 12 is shown in FIG. 3, the epoxy application system 12 being adapted to apply a liquid epoxy having particulate constituents to an optical component in accordance with one embodiment of the present invention. To avoid repetition, only the upper epoxy application system 12 is discussed in detail herein below. However, the lower epoxy application system 14 shown in FIGS. 1 and 2 is operable in the same manner as the epoxy application system 12. Of course, as noted previously, other embodiments of the present invention need not even be provided with the lower epoxy application system 14 at all.

As can be seen in FIG. 3, the epoxy application system 12 includes an epoxy reservoir 30 which stores the liquid epoxy to be applied. The epoxy reservoir is movable to a park position shown using stage 24 which is connected to cylinder 28 discussed previously. An applicator 32 is fluidically connected to the epoxy reservoir 30, the applicator 32 including an applicator tip 34 with an opening for dispensing the epoxy from the epoxy reservoir 30. In addition, the epoxy application system 12 also includes an actuator 36 mechanically connected to the epoxy reservoir 30 and a manual rotary locator 38, the functions of these components being discussed in further detail below.

A further enlarged schematic view of the of various components of the epoxy application system 12 is shown in FIG. 4. As can be seen, the epoxy reservoir 30 has an axis LA and when the epoxy application system 12 is positioned in the park position, the epoxy reservoir 30 is positioned horizontally as shown in FIG. 2 so that gravitational force indicated by downward arrow G acts substantially perpendicular to the axis LA. In accordance with the present embodiment, the actuator 36 is operable to periodically invert the epoxy reservoir 30 when the epoxy reservoir 30 is in the park position. In this regard, the actuator 36 is a pneumatic actuator in the present illustrated embodiment but a hydraulic actuator, or an electric motor are also appropriate for use in other embodiments.

This periodic inversion of the epoxy reservoir 30 by the actuator 36 ensures that the particulate constituents of the liquid epoxy does not settle to the bottom of the epoxy reservoir 30 as in the prior art epoxy application systems, even if the epoxy is not actually dispensed for an extended period of time. In this regard, the actuator 36 of the epoxy application system 12 is also preferably provided with a timing circuit (not shown) adapted to periodically actuate the actuator 36 based on settling characteristics of the epoxy or a predetermined time interval based on some other parameter. In the preferred embodiment shown, the actuator 36 is adapted to rotate the epoxy reservoir 30, 180 degrees along the axis LA upon actuation, alternating the rotation between a clockwise direction rotation and a counter-clockwise direction rotation. In this manner, substantial homogeneity of the particulate constituents in the epoxy stored in the epoxy reservoir 30 is maintained by the epoxy application system 12 in accordance with the present invention.

It should be noted that whereas in the illustrated embodiment of FIG. 4, the axis LA is defined to be extending along the center of the epoxy reservoir 30 and the center of the actuator 36, the axis LA of the epoxy reservoir 30 need not correspond to the center of the actuator 36 in other embodiments so that the center of the epoxy reservoir 30 is offset from the center of the actuator 36. For instance, in another embodiment, the epoxy reservoir is mounted to a bracket attached to the actuator so that when the bracket is rotated, the epoxy reservoir is inverted in accordance with the present invention. Even in such an embodiment, the actuator would still invert the epoxy reservoir relative to the gravitational force G. In this manner, substantial homogeneity of the particulate constituents in the epoxy stored in the epoxy reservoir 30 is maintained by the epoxy application system 12 in accordance with the present invention. Moreover, the manual rotary locator 38 can be used to manually rotate the epoxy reservoir 30 to adjust the positioning of the applicator 32.

In the illustrated embodiment of FIG. 4, the applicator 32 is fixedly mounted to the epoxy reservoir 30. Consequently, when the epoxy reservoir 30 is rotated, the applicator 32 is also rotated as well. Of course, in other embodiments, the applicator 32 need not be fixedly mounted to the epoxy reservoir 30. As can also be clearly seen, the applicator 32 in accordance with the illustrated embodiment includes a bent portion which allows more accurate placement of the applicator tip 34 proximate to the optical component to thereby facilitate the application of the epoxy. The positioning of the applicator tip 34 also be manually adjusted using the manual rotary locator 38.

In the embodiment of the present invention shown in FIG. 4, the epoxy application system 12 includes a vacuum device 40 proximate to the applicator tip 34 when the epoxy application system 12 is in the park position shown in FIG. 2. The vacuum device 40 includes an opening 42 which is fluidically connected to a vacuum source (not shown) of the type generally known in the art so that the vacuum device 40 vacuums excess epoxy dripping from the applicator tip 34 when the epoxy reservoir 30 is in the park position. By providing such a vacuum device 40, the maintenance and cleaning requirements of the epoxy application system 12 is further reduced thereby increasing productivity while decreasing costs.

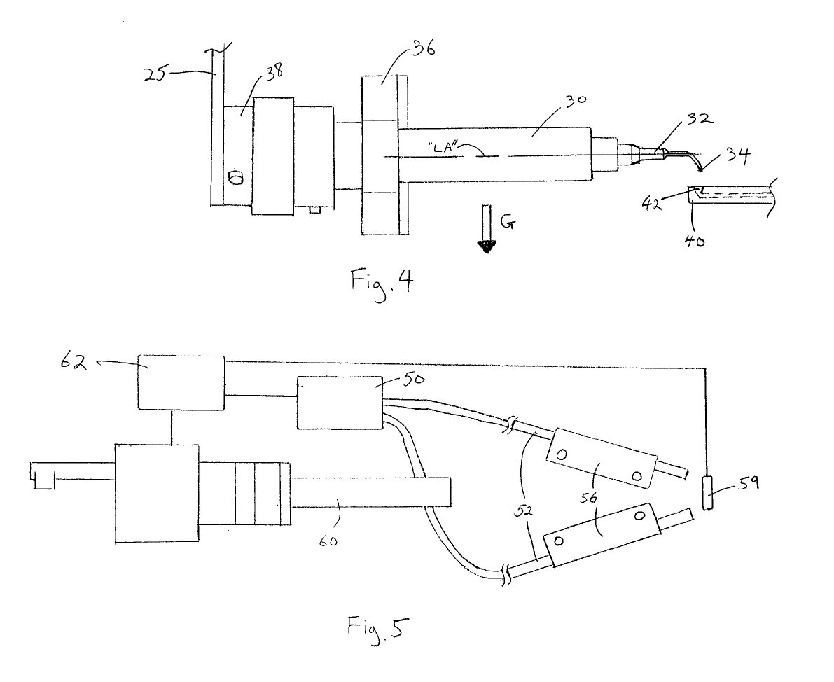

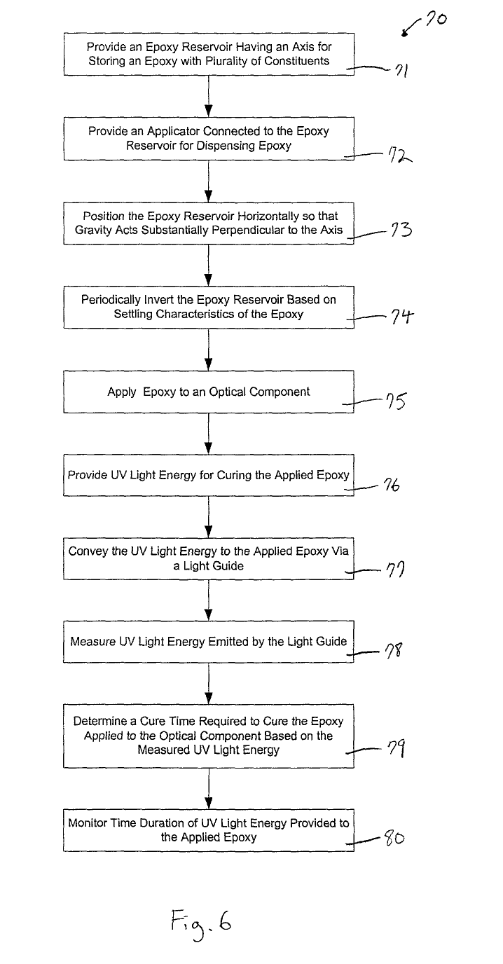

Referring again to FIGS. 2 and 3, the epoxy application system 12 in accordance with the illustrated embodiment of the present invention further includes provisions for curing the epoxy applied to the optical component. These provisions are most clearly shown in FIG. 5 and includes an ultraviolet (UV) light source 50 (schematically shown) that provides UV light energy to cure the epoxy applied to the optical component. In this regard, the UV light energy is conveyed from the light source 50 to a location proximate the applicator 32 using liquid filled light guides 52. As shown, first ends of the light guides 52 are optically connected to the UV light source 50 and second ends 54 having lenses (not shown) adapted to emit the UV light energy from the UV light source 50 are secured via brackets 56 which are mounted to an extendable cylinder 57. Upon actuation of the extendable cylinder 57, the second ends 54 of the light guides 52 are positioned in the manner shown in FIG. 3 so that the lenses are proximate to the optical component to provide UV light energy to the epoxy which is applied in the manner discussed previously. Thus, the UV light energy from the UV light source 50 is conveyed to the epoxy applied to the optical component to thereby cure the epoxy to the extent desired. In addition, it should be noted that in other embodiments, the light guides 52 fork off from one end which is optically connected to the UV light source. Of course, upon curing of the applied epoxy to the extent desired, the extendable cylinder 57 is actuated again to retract the light guides 52 so that the optical component can be further processed.

In the illustrated embodiment of FIG. 5, the epoxy application system 12 further includes at least one UV light energy detector such as a silicon detector 59 which is adapted to measure UV light energy emitted at the second ends 54 of the light guides 52. It should initially be noted that in other embodiments, other UV light energy detectors such as a UV sensor is used to measure UV light energy emitted at the second ends 54 of the light guides 52 instead of the silicon detector 59. As can be seen, a controller 62 is also provided to determine a cure time required to cure the epoxy applied to the optical component based on the UV light energy emitted by the light guides 52 as measured by the silicon detector 59.

This is an advantageous feature of the illustrated embodiment of the epoxy application system 12 in that the light guides 52 or the lenses (not shown) of the light guides 52 typically degrade over time and convey less UV light energy as the light guides 52 are used. Moreover, the UV light source 50 itself, can degrade over time so that less UV light energy is provided to the light guides 52 while shutters (not shown) provided in most UV light sources 50 can malfunction and become stuck in a closed position. By initially measuring the actual output of the UV light energy through the light guides 52, the above noted deficiencies can be compensated for by extending the cure time correspondingly. Thus, the cure time that is determined by the controller 62 is increased as the light guides 52 and/or the UV light source 50 degrade and provide less UV light energy. The cure time is determined by the controller 62 using a predefined algorithm or by using a look up table which correlates the UV light energy measured by the silicon detector 59 to a cure time. In this manner, the UV light energy is provided for the appropriate duration of time to cure the applied epoxy of the optical component to the extent desired.

Furthermore, the epoxy application system 12 is also provided with a monitoring system such as camera vision system 60 shown in FIG. 5 to ensure provision of the UV light energy for at least the determined cure time described above. This is attained by using the camera vision system 60 to monitor the actual duration of time which the light guides 52 provide the UV light energy to the applied epoxy and ensuring via the controller 62 that the UV light energy is, in fact, provided for the full duration of the cure time as determined by the controller 62. The camera vision system 60 is adapted to detect the increase in the amount of UV light energy in the proximate area of the optical component which occurs when UV light is provided to the optical component. In addition, this ensures that the above described shutters of the UV light source 50 properly opened to provide the desired UV light energy. Therefore, by monitoring the provision of the UV light energy, an effective feedback control is provided. In the above described manner, the epoxy application system 12 in accordance with the present embodiment ensures that the desired amount of UV light energy is actually provided to the applied epoxy.

It should also be noted that the embodiment utilizing the camera vision system 60 as shown in FIGS. 3 and 5 is especially advantageous in that the camera vision system 60 is used to accurately monitor the position of an optical fiber being fed to make the optical component. For instance, as previously described, if an optical coupler is being made, a stripped portion of an optical fiber must be precisely positioned within the glass tube so that the glass tube can be collapsed around the stripped portion. However, the stripped portion should not extend through the uncollapsed ends of the tube because the epoxy applied to the uncollapsed ends of the glass tube bond with the cladding around the optical fiber on the unstripped portion to provide the fibers with pull strength. The camera vision system 60 is used to precisely monitor the beginning and end of the stripped region so that precise positioning of the stripped portion and the unstripped portion relative to the glass tube is attained.

Referring again to FIGS. 1 and 2, it should be noted that the epoxy application station 10 in accordance with the illustrated embodiment is provided with only one camera vision system 60 shown in FIG. 5 which is provided with the upper epoxy application system 12. However, it should be readily apparent that in other embodiments, the lower epoxy application system 14 is also provided with a monitoring system in a similar manner to ensure the desired amount of UV light energy is provided to the applied epoxy.

In view of the above, it should also be apparent that the another aspect of the present invention is to provide a method for applying an epoxy having plurality of constituents to an optical component. FIG. 6 is a flow chart 70 illustrating such a method in accordance with one embodiment of the present invention. As can be seen, the method includes the steps of providing an epoxy reservoir having an axis for storing an epoxy with plurality of constituents in step 71, and providing an applicator connected to the epoxy reservoir for dispensing the epoxy in step 72. The present method also includes the step of positioning the epoxy reservoir horizontally such that gravity acts substantially perpendicular to the axis in step 73, and periodically inverting the epoxy reservoir in step 74 based on settling characteristics of the epoxy to substantially maintain homogeneity of the plurality of constituents in the epoxy. Preferably, the step 74 of periodically inverting the epoxy reservoir includes the step of rotating the epoxy reservoir 180 degrees along the axis alternating between a clockwise direction rotation and a counter-clockwise direction rotation.

In accordance with the illustrated embodiment of the present method, the epoxy from the epoxy reservoir is applied to an optical component in step 75. In step 76, UV light energy is provided to cure the applied epoxy, the UV light energy being conveyed to the applied epoxy via a light guide in step 77. The UV light energy emitted by the light guide is measured in step 78, and based on the measured UV light energy, a cure time required to cure the epoxy applied to the optical component is determined in step 79. The time duration during which the UV light energy is actually provided to the applied epoxy is monitored in step 80 to ensure UV light energy is provided to the applied epoxy for at least the determined cure time of step 79. In the above described manner, the present method can be used to ensure that the desired amount of UV light energy is provided to the applied epoxy.

Of course, in other embodiments of the present method, other additional steps are provided. For instance, in another embodiment of the present method, the epoxy reservoir and the applicator are mounted on a movable stage and further includes the step of moving the stage to position the applicator proximate to the optical component to allow application of the epoxy thereto. In still another embodiment, the applicator includes an applicator tip with an opening and the present method further includes the step of vacuuming an opening of the applicator to remove excess epoxy dripping from the opening.

While various embodiments in accordance with the present invention have been shown and described, it is understood that the invention is not limited thereto. The present invention may be changed, modified and further applied by those skilled in the art. Therefore, this invention is not limited to the detail shown and described previously, but also includes all such changes and modifications.

We claim:

1. An epoxy application system for applying a liquid epoxy having particulate constituents to an optical component comprising:
an epoxy reservoir having an axis and being movable to a park position in which said epoxy reservoir is positioned horizontally in a manner that gravity acts substantially perpendicular to said axis;
an applicator connected to said epoxy reservoir, said applicator including an applicator tip with an opening fluidically connected to said epoxy reservoir for dispensing said epoxy from said epoxy reservoir to said optical component; and
an actuator mechanically connected to said epoxy reservoir, said actuator being operable to periodically invert said epoxy reservoir when said epoxy reservoir is in said park position to substantially maintain homogeneity of said particulate constituents in said epoxy.

2. The epoxy application system of claim 1, wherein said actuator is at least one of a pneumatic actuator, a hydraulic actuator and, an electric motor.

3. The epoxy application system of claim 1, wherein said applicator is fixedly mounted to said epoxy reservoir and is inverted with said epoxy reservoir.

4. The epoxy application system of claim 3, wherein said epoxy reservoir, said applicator, and said actuator are mounted on a movable stage.

5. The epoxy application system of claim 3, wherein said applicator includes a bent portion to facilitate application of said epoxy.

6. The epoxy application system of claim 1, further including a timing circuit adapted to periodically actuate said actuator based on settling characteristics of said epoxy.

7. The epoxy application system of claim 1, wherein said actuator is adapted to rotate said epoxy reservoir 180 degrees along said axis upon actuation.

8. The epoxy application system of claim 7, wherein said actuator is further adapted to rotate said epoxy reservoir 180 degrees along said axis upon actuation, alternating said rotation between a clockwise direction rotation and a counter-clockwise direction rotation.

9. The epoxy application system of claim 1, further including a vacuum device proximate to said opening of said applicator tip when said epoxy reservoir is in said park position, said vacuum device being adapted to vacuum excess epoxy dripping from said opening of said applicator tip.

10. The epoxy application system of claim 1, further including an energy source for providing curing energy to cure said epoxy applied to said optical component.

11. The epoxy application system of claim 10, wherein said energy source is a ultraviolet (UV) light source for providing UV light energy.

12. The epoxy application system of claim 11, further including a liquid filled light guide for conveying said UV light energy from said UV light source to said epoxy applied to said optical component, said light guide including one end optically connected to said UV light source and a second end adapted to emit said UV light energy from said UV light source.

13. The epoxy application system of claim 12, further including at least one UV light energy detector adapted to measure UV light energy emitted at said second end of said light guide.

14. The epoxy application system of claim 13, further including a controller adapted to determine a cure time required to cure said epoxy applied to said optical component based on said UV light energy emitted by said light guide as measured by said UV light energy detector.

15. The epoxy application system of claim 14, further including a monitoring system to ensure provision of said UV light energy for at least said determined cure time.

16. The epoxy application system of claim 15, wherein said monitoring system is a camera vision system.

17. A method for applying an epoxy having plurality of constituents to an optical component comprising the steps of:
providing an epoxy reservoir having an axis;
providing an applicator connected to said epoxy reservoir for dispensing said epoxy from said epoxy reservoir;
positioning said epoxy reservoir horizontally such that gravity acts substantially perpendicular to said axis; and
periodically inverting said epoxy reservoir to substantially maintain homogeneity of said plurality of constituents within said epoxy.

18. The method of claim 17, wherein said epoxy reservoir and said applicator are mounted on a movable stage, further including the step of moving said stage to position said applicator proximate to said optical component to allow application of said epoxy thereto.

19. The method of claim 17, further including the step of inverting said epoxy reservoir periodically based on settling characteristics of said epoxy.

20. The method of claim 17, wherein said step of inverting said epoxy reservoir includes rotating said epoxy reservoir 180 degrees along said axis.

21. The method of claim 20, wherein said epoxy reservoir is rotated 180 degrees along said axis alternating between a clockwise direction rotation and a counter-clockwise direction rotation.

22. The method of claim 17, wherein said applicator includes an applicator tip with an opening, further including the step of vacuuming said opening of said applicator tip to remove excess epoxy dripping from said opening of said applicator tip.

23. The method of claim 17, further including the step of curing said epoxy applied to said optical component.

24. The method of claim 23, wherein said step of curing includes the step of irradiating said epoxy with UV light energy.

25. The method of claim 24, said step of curing further includes the step of conveying UV light energy to said applied epoxy through a liquid filled light guide.

26. The method of claim 25, further including the step of measuring UV light energy emitted by said light guide.

27. The method of claim 26, further including the step of determining a cure time required to cure said epoxy applied to said optical component based on said measured UV light energy emitted by said light guide.

28. The method of claim 27, further including the step of monitoring time duration of providing said UV light energy to ensure UV light energy is provided to said epoxy applied to said optical component for at least said determined cure time.
